(19) United States
(12) Patent Application Publication
(10) Pub. No.: US 2026/0244476 A1
(43) Pub. Date: Aug. 20, 2026

(54) MODULAR SYSTEM FOR PROCESSING PIPELINES

(71) Applicant: Board of Trustees of Michigan State University, East Lansing, MI (US)

(72) Inventors: Daniel KENT, Okemos, MI (US); Dominic MAZZA, Tampa, FL (US); Hayder RADHA, East Lansing, MI (US)

(73) Assignee: Board of Trustees of Michigan State University, East Lansing, MI (US)

(21) Appl. No.: 19/543,072

(22) Filed: Feb. 18, 2026

Related U.S. Application Data
(60) Provisional application No. 63/759,626, filed on Feb. 18, 2025.

(51) Int. Cl. G06F 9/455

(52) U.S. Cl. CPC G06F 9/45508; G06F 9/45516

(57) ABSTRACT

A system for constructing and testing processing pipelines is disclosed. In some examples, the system includes a node database comprising a plurality of nodes, an application programming interface (API) operable with the node database to present a processing pipeline comprising a plurality of nodes selected from the node database, and a runtime engine configured to direct an operating system to instantiate the processing pipeline according to an optimization strategy.

### CROSS-REFERENCE TO RELATED APPLICATION

The present application claims priority to provisional patent application Ser. No. 63/759,626, filed on Feb. 18, 2025, which is incorporated by reference herein.

### BACKGROUND AND SUMMARY

The present disclosure relates to reducing or eliminating redundant components in a software perception system or other construct modeled as a processing pipeline. The disclosure applies to enabling rapid reconfiguration for testing different combinations of algorithms, datasets, and outputs. Furthermore, the disclosure allows for enhanced understanding of how a perception system is tied together and how its data flows through different components.

The rise of neural networks as the core of modern perception systems is partially driven by the increasing ease of implementation thanks to modern frameworks that simplify the process of building, training, and deploying novel neural networks. However, for R&D engineers, including those in the automotive industry, integrating existing networks with other networks or even other datasets is often a highly manual, time-consuming process. Some published networks contain code that solves common problems in different ways; for example, such networks frequently contain code for input parsing, hyperparameter selection, processing device selection, and output file writing. These additional layers tend to complicate integration between disparate perception algorithms, typically requiring specific translation between the outputs and inputs of each network, and often requiring the data to be transferred back and forth between tensor processing memory and main system memory. Furthermore, many algorithms, especially neural network-based ones, require specific versions of underlying frameworks and libraries, which inevitably causes system-level incompatibilities to arise, further complicating integration efforts.

While some work has been done to ease integration, these efforts typically focus on porting a neural network and its weights to other frameworks. However, these translation frameworks typically do not reciprocally support all features required for certain networks. For example, sparse convolution, a common layer used in many 3D detection networks, is an important layer operation that is not yet defined in a known specification. Even if such layers could be supported, i.e., defined, the existence of portable network definitions still does not eliminate the manual effort required to properly interconnect multiple networks and datasets together. As a result, there has been some research interest in developing frameworks to abstract and modularize existing detection algorithms, many finding success despite the previous existence of the underlying algorithms that are incorporated into these frameworks. Nevertheless, such solutions still require a great deal of effort, labor-intensive software development, intricate know-how, and potentially long hours if not days for configuring and/or modifying a vast body of software and many hyper-parameters.

In that context, the present disclosure finds that there is a need for a utility or framework that reduces the manual effort required to connect disparate networks, datasets, and other processing modules, ideally with existing support for popular algorithms and datasets. To this end, the present disclosure proposes a Robust Adaptive Modular Perception System (RAMPS) as a framework for integrating disparate perception components. In some examples, the present disclosure is advantageous for use in developing, constructing, testing, training, and otherwise manipulating autonomous vehicles and ADAS systems relative to a corresponding processing pipeline, optionally as a single graph-based architecture.

In some examples, the present disclosure provides a fully modular, multimodal, fusion-based underlying software platform for training and testing processing pipelines. While it provides access to any of the intricate settings and configurations for users who are experts in perception solutions and algorithms, the present disclosure eliminates or significantly reduces the amount of time and effort needed for training and testing any combination of perception networks and architectures. For example, and through a graphical user interface (GUI), the present disclosure enables a user to import, integrate, and/or select any input multimodal dataset (publicly available or private), any 2D object detector, any 3D object detector, and a corresponding suitable fusion solution. In some examples, this is accomplished by defining clear nodes and APIs among a variety of modules and components, thereby, in some examples, enabling a truly plug-and-play paradigm for processing pipelines' training and testing.

The present disclosure enables the integration of end-to-end perception pipelines including object detection solutions, tracking, and/or forecasting algorithms. Such a pipeline may include 2D object and 3D object detectors, a late fusion module, a tracking by detection solution, and a forecasting module. The present disclosure can train or test any subset of such end-to-end pipelines depending on their needs or interest. The present disclosure also supports 3D object detection modules that are based on multimodal deep (or early) fusion by simply connecting the appropriate data nodes as input to these modules. The present disclosure enables these capabilities while maintaining low overhead and minimal effort for training and testing such end-to-end perception networks and architectures.

In some examples, the present disclosure is designed to work with input real-time multimodal data (e.g., camera, lidar, and radar data) through an interface with ROS. This provides a compelling capability for testing and inference of an end-to-end perception pipeline in real-time.

In some examples, the present disclosure is designed to complement other popular perception platforms. In that context, the present disclosure can import architectures and networks from other platforms using its node-based underlying modular architecture. In some examples, the importing and integration process of the present disclosure are advantageous in terms of Software Line of Code (SLOC) reduction while maintaining similar or (sometimes significantly) lower inference time.

In some examples, a system for reducing or eliminating redundant components in a software perception system is provided. The system enables rapid reconfiguration for testing different combinations of algorithms, datasets, and outputs. The system further enables enhanced understanding of how a perception system is tied together and how its data flows through different components.

One aspect of the present disclosure provides a system for constructing and testing processing pipelines. In some examples, the system includes a node database including a plurality of nodes having inputs and outputs defined according to respective input and output tensors, wherein each node of the plurality of nodes executes routines in furtherance of a related task associated with at least one of a data source, a data sink, and an algorithm, a network application programming interface (API) configured to identify a plurality of selected nodes of the plurality of nodes to be arranged into a processing pipeline based on corresponding user inputs to a user interface (UI), an operating system coupled with a central processing unit (CPU) having a CPU memory and a plurality of accelerator processing units (APUs) each having an APU memory, and a runtime engine executable with the operating system to direct instantiation of the processing pipeline according to an optimization strategy, wherein the runtime engine, prior to instantiating the processing pipeline, is configured to perform a conformance check of the processing pipeline and generate the optimization strategy to structure the processing pipeline as an acyclic graph that maximizes use of the APU memory relative to batch sizing of the input and output tensors of the plurality of selected nodes.

In some examples, the network API is configured to present the plurality of nodes stored in the node database to a user to enable selection via a node selection menu of the UI, wherein the network API identifies the plurality of selected nodes comprising the processing pipeline according to corresponding user inputs to the node selection menu.

In some examples, the node selection menu includes an available data source menu to present selectable nodes of the plurality of nodes that operate as a data source, an available data sink menu to present selectable nodes of the plurality of nodes that operate as a data sink, and an available algorithms menu to present selectable nodes of the plurality of nodes that operate as an algorithm.

In some examples, the node selection menu includes an interactive pipeline interface configured to visually represent and spatially arrange the plurality of selected nodes relative to each other in response to corresponding user inputs to the node selection menu.

In some examples, the node selection menu includes an interactive pipeline interface configured to present the plurality of selected nodes and a connection tool configured to draw connection lines between the inputs and outputs of the plurality of selected nodes in response to corresponding user inputs to the node selection menu, wherein the connection lines represent edges and dependent processing pathways between adjoining nodes of the processing pipeline.

In some examples, the runtime engine is configured to perform the conformance check contemporaneously with drawing of connection lines between the plurality of selected nodes to provide real-time conformance feedback via the node selection menu.

In some examples, the conformance check is configured to indicate an error in response to identifying an incompatibility between the input and output tensors of adjoining ones of the plurality of selected nodes connected together in the node selection menu with connection lines, wherein the connection lines represent edges and dependent processing pathways between adjoining nodes of the processing pipeline.

In some examples, the incompatibility is based on a tensor type and a tensor size of the input and output tensors.

In some examples, the runtime engine is configured to assign a universal unique identifier (UUID) to each input and output of the processing pipeline and assign a name to each of the plurality of nodes.

In some examples, the UUID associated with the inputs and outputs and the name associated with the plurality of nodes are operable to permit multiple instances of a node of the plurality of nodes within the processing pipeline to be differentiated from both a machine perspective and a human perspective within the acyclic graph.

In some examples, the plurality of nodes are each configured to implement a base object interface.

In some examples, the base object interface includes an object constructor that accepts a dictionary with configuration values and a universal unique identifier (UUID), a process function that accepts inputs, processes data according to an underlying algorithm, and outputs data to be processed by downstream nodes, a get_config function that retrieves configuration values, a set_config function that changes configuration values, an input function that declares inputs, an output function that declares outputs, a train function that indicates whether trainable parameters are available, a valid function that indicates an underlying node configuration is functioning, and a category function that aids in sorting and discoverability.

In some examples, the runtime engine is configured to instantiate the plurality of selected nodes comprising the processing pipeline synchronously.

In some examples, the runtime engine is configured to instantiate one or more nodes of the plurality of selected nodes comprising the processing pipeline asynchronously.

One aspect of the present disclosure provides a method for constructing and testing processing pipelines. In some examples, the method includes identifying a plurality of selected nodes selected from a plurality of nodes stored in a node database based on corresponding user inputs to a node selection menu presented through a user interface (UI) accessible via a network application programming interface (API), wherein each node of the plurality of nodes includes inputs and outputs defined according to respective input and output tensors and executes routines in furtherance of a related task associated with at least one of a data source, a data sink, and an algorithm, generating a processing pipeline for the plurality of selected nodes according to a node arrangement of the plurality of selected nodes within an interactive pipeline interface of the node selection menu, wherein the node arrangement is determined according to corresponding user inputs to the node selection menu and includes connection lines between the inputs and outputs of the plurality of selected nodes to represent edges and dependent processing pathways between adjoining nodes of the processing pipeline, and directing an operating system comprising a central processing unit (CPU) having a CPU memory and a plurality of accelerator processing units (APUs) each having an APU memory to instantiate the processing pipeline according to an optimization strategy, including, prior to instantiating the processing pipeline, performing a conformance check of the processing pipeline and generating the optimization strategy to structure the processing pipeline as an acyclic graph that maximizes use of the APU memory relative to batch sizing of the input and output tensors of the plurality of selected nodes.

In some examples, the method includes performing the conformance check contemporaneously with drawing of the connection lines to provide real-time conformance feedback via the node selection menu, including indicating an error in response to identifying an incompatibility between the input and output tensors of adjoining ones of the plurality of selected nodes connected together with connection lines.

In some examples, the method includes presenting the plurality of nodes in the node selection menu relative to an available data source menu that presents selectable nodes of the plurality of nodes configured to operate as a data source, an available data sink menu that presents selectable nodes of the plurality of nodes configured to operate as a data sink, and an available algorithms menu that presents selectable nodes of the plurality of nodes configured to operate as an algorithm.

One aspect of the present disclosure provides a system for constructing and testing processing pipelines. In some examples, the system includes a node database comprising a plurality of nodes, wherein each node of the plurality of nodes includes inputs and outputs defined according to respective input and output tensors and is configured to execute routines in furtherance of a related task, a node selection menu configured to present an interactive pipeline interface through a user interface (UI) accessible via a network application programming interface (API), wherein the interactive pipeline interface is configured to present a processing pipeline comprising a plurality of selected nodes in response to corresponding user inputs indicating selection of the plurality of selected nodes from the plurality of nodes in the node database, wherein the processing pipeline includes connection lines between the inputs and outputs of the plurality of selected nodes to represent edges and dependent processing pathways between adjoining nodes in the processing pipeline, and a runtime engine configured to direct an operating system to instantiate the processing pipeline according to an optimization strategy, wherein the operating system includes a central processing unit (CPU) having a CPU memory and a plurality of accelerator processing units (APUs) each having an APU memory and the optimization strategy structures the processing pipeline as an acyclic graph that maximizes use of the APU memory relative to batch sizing of the input and output tensors of the plurality of selected nodes.

In some examples, the runtime engine is configured to perform a conformance check contemporaneously with drawing of the connection lines to provide real-time conformance feedback via the node selection menu, wherein the conformance check is configured to indicate an error in response to identifying an incompatibility between the input and output tensors of adjoining ones of the plurality of selected nodes.

In some examples, the node selection menu is configured to present the plurality of nodes relative to an available data source menu that presents selectable nodes of the plurality of nodes configured to operate as a data source, an available data sink menu that presents selectable nodes of the plurality of nodes configured to operate as a data sink, and an available algorithms menu that presents selectable nodes of the plurality of nodes configured to operate as an algorithm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a functional diagram of a modular processing system in accordance with an example of the present disclosure;

FIG. 2 is a functional diagram of a node selection menu in accordance with an example of the present disclosure;

FIG. 3 is a flowchart of a method for importing nodes in accordance with an example of the present disclosure;

FIG. 4 is a flowchart of a method for instantiating a processing pipeline in accordance with an example of the present disclosure; and

FIG. 5 is a flowchart of a method for checking node loading in accordance with an example of the present disclosure.

Corresponding reference numerals indicate corresponding parts throughout the several views of the drawings.

### DETAILED DESCRIPTION

Example embodiments will now be described more fully with reference to the accompanying drawings.

In some examples, the present disclosure provides a system for constructing, training, and testing processing pipelines. The processing pipelines, for example, correspond with a series of interconnected nodes or processing stages that work together to process and transform data, where each node executes a specific task, such as data input and/or output, algorithmic processing, or data manipulation, and the output of one node serves as the input to the next node, enabling the creation of complex data processing workflows.

In some examples, the present disclosure reduces or eliminates redundant components in a processing pipeline configured to operate as a software perception system. The configuration of the processing pipeline as a software perception system is presented for exemplary and non-limiting purposes to demonstrate advantageous capabilities of the present disclosure in constructing, training, and testing software, processes, algorithms, etc. in furtherance of improving operation of the attendant systems when executing in computers, servers, processors, and other logically implemented elements.

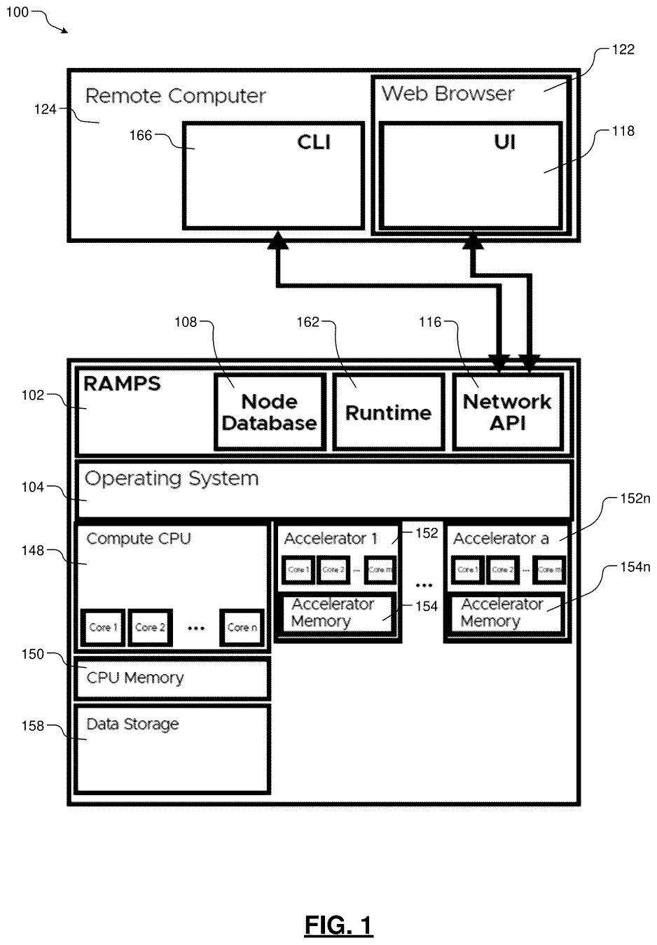

Referring to FIG. 1, a system 100 is observable for constructing, training, and testing a processing pipeline in accordance with an example of the present disclosure. In some examples, the system 100 enables rapid reconfiguration for testing different combinations of algorithms, datasets, and outputs. The system 100 further enables enhanced understanding of how a perception system or other system operates based on how the processing pipeline is arranged and how the related data flows through the processing pipeline. In some examples, the system 100 provides node-based processing whereby various processing pipelines can be constructed utilizing individual nodes, with individual nodes being selectable and arrangeable relative to each other to define edges and dependent processing pathways that can be manipulated to test performance, training, etc.

Accordingly, the system 100 includes a framework architecture 102 operable with an operating system 104 of a suitable computer, server, machine, etc. for constructing and evaluating processing pipelines in a modular manner utilizing a variety of nodes available from a node database 108. In other words, the available nodes are self-contained processing units that execute in furtherance of a specific task, such as data input/output, algorithmic processing, or data manipulation, and have defined inputs and outputs that enable them to be connected to other nodes to form a complex data processing workflow. In some examples, the nodes are configured to execute routines, which are predominantly described with respect to tasks associated with a data source, a data sink, and/or an algorithm. This is done for exemplary and non-limiting purposes as the nodes may be configured to support a wide variety of activities, processes, etc. beyond those typically associated with a data source, data sink, and/or an algorithm.

In some examples, each node available from the node database 108 is configured with inputs and outputs defined relative to corresponding input and output tensors. In some examples, the input and output tensors provide a multi-dimensional array of numerical values, data, etc. and are used to represent data in a way that can be processed by computers, particularly in the context of machine learning and neural networks, e.g., to facilitate modeling vehicle perception systems. The input and output tensors, for example, provide a multi-dimensional array that generalizes scalars (0D), vectors (1D), matrices (2D), and higher-order structures, enabling efficient storage and manipulation of complex data such as images or point clouds.

The input and output tensors, for instance, are used to better facilitate neural network modules that may be incorporated into the system 100 as nodes, e.g., an underlying neural network framework to represent the underlying tensors is optionally employed as a basis of node-to-node communication. While other data representations are contemplated, the use of input and output tensors advantageously provides direct compatibility with off-the-shelf neural network-based method nodes and direct memory sharing between connected nodes, with correct memory sharing offering a performant pipeline having hardware acceleration that minimizes or eliminates the expense of transferring data from system memory to accelerator memory.

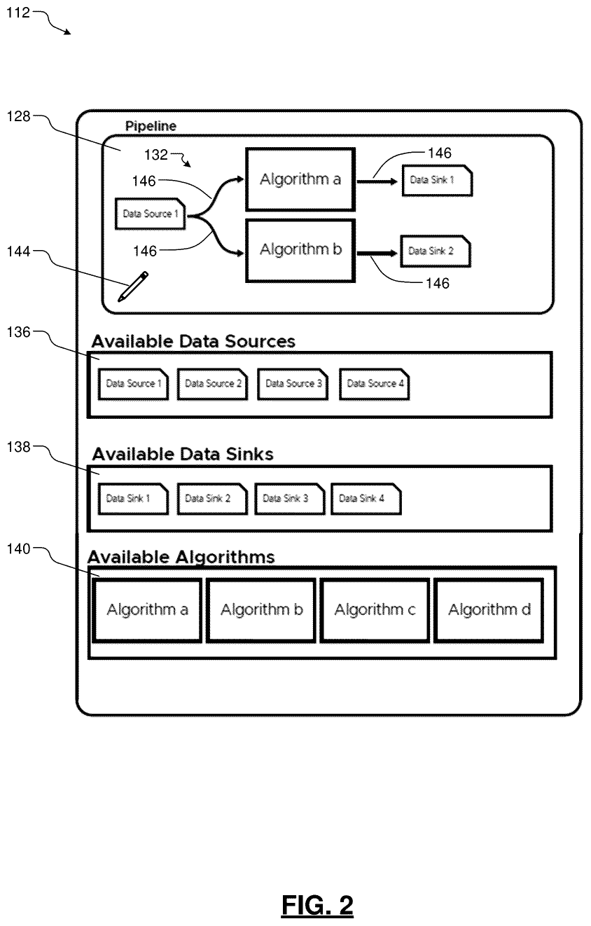

Referring to FIG. 2, a node selection menu 112 is observable for selecting nodes from the node database 108 to be used in constructing a processing pipeline. Returning briefly to FIG. 1, the node selection menu 112, for example, is accessible via a network application program interface (API) 116 of the framework architecture 102, such as in the illustrated manner using a user interface (UI) 118 accessible through a web browser 122 of a remote computer 124. The remote computer 124 is shown for non-limiting purposes as representative of various mechanisms available for interacting with the framework architecture 102. The remote computer 124, for example, is advantageous in enabling an engineer tasked with testing a vehicle perception system or the like to model the vehicle perception system from a remote location while the corresponding processing pipeline executes elsewhere.

As shown in FIG. 2, the node selection menu 112 includes an interactive pipeline interface 128 configured to present a processing pipeline 132 comprising a plurality of nodes selected from the node database 108. In the illustrated example, the processing pipeline 132 is shown to include nodes selected from an available data source menu 136 used to present selectable nodes that operate as a data source, an available data sink menu 138 used to present selectable nodes that operate as a data sink, and an available algorithm menu 140 used to present selectable nodes that operate as an algorithm. By way of example and without limitation, the processing pipeline 132 includes a data source 1 node, an algorithm a node, an algorithm b node, a data sink 1 node, and a data sink 2 node.

Each of the available data source menu 136, available data sink menu 138, and the available algorithm menu 140 include additional nodes available for selection from the node database 108. The available data source menu 136, for example, additionally includes a data source 2 node, a data source 3 node, and a data source 4 node. The available data sink menu 138, for example, additionally includes a data sink 2 node, a data sink 3 node, and a data sink 4 node. The available algorithm menu 140, for example, additionally includes an algorithm c node and an algorithm d node. The various nodes observable in FIG. 2 are presented for exemplary purposes as non-limiting representations of a wide variety of nodes that may be utilized in accordance with the present disclosure to construct the processing pipeline 132.

In some examples, the node selection menu 112 includes a connection tool 144 configured to draw or otherwise establish connection lines 146 between the inputs and outputs of the plurality of selected nodes in response to corresponding user inputs to the node selection menu 112. The connection lines 146, for example, represent edges and dependent processing pathways between adjoining nodes of the processing pipeline 132. In this manner, the interactive pipeline interface 128 is configured to visually represent and spatially arrange the selected nodes relative to each other to define the processing pipeline 132, optionally in a rearrangeable manner whereby a user may drag-and-drop nodes in and out of the interactive pipeline interface 128.

Returning to FIG. 1, the operating system 104 in some examples is coupled with a compute central processing unit (CPU) 148 having a CPU memory 150, a plurality of accelerator processing units (APUs) 152 . . . 152n each having an APU memory 154 . . . 154n, and a data storage 158. In accordance with an advantageous aspect of the present disclosure, the framework architecture 102 includes a runtime engine 162 executable with the operating system 104 to direct instantiation of the processing pipeline 132 according to an optimization strategy. The runtime engine 162, for example, prior to instantiating the processing pipeline 132, is configured to perform a conformance check of the processing pipeline 132 and generate the optimization strategy to structure the processing pipeline 132 as an acyclic graph that maximizes use of the APU memory relative to batch sizing of the input and output tensors of the selected nodes comprising the processing pipeline 132.

Typically, off-the-shelf perception-based algorithms contain their own routines for data input and output, often reading data in from a file and outputting data to a separate file. While this approach allows for an algorithm to exist on its own with demonstrable examples, there is additional processing overhead and software lines of code to support the input and output, especially if data are transferred back and forth between CPU memory and graphics processing unit (GPU) or tensor processing unit (TPU) memory. Furthermore, the attendant routines may not share a common codebase, which leaves open the possibility that each implementation is mutually incompatible, which could lead to processing errors.

With this in mind, the system 100, for example, solves some of the data input, flow, and output issues using a node-based processing system and architecture. The present disclosure optionally allows the same code to run on simulated or live data, in real-time, and/or at different simulation speeds, without a custom network protocol for node-to-node communication, and optionally using memory sharing suited for GPU, TPU, and/or APU shared memory transport, which as noted is beneficial for hardware acceleration. Likewise, the present disclosure maximizes the modularity benefits of a node-based system, while avoiding communication overhead between nodes, so that users are able to more quickly build and iterate on perception pipelines.

In some examples, the system 100 supports a large set of nodes such that some nodes may inevitably run faster than others. Optionally, rather than waiting for all nodes in the processing pipeline 132 to finish processing a single iteration before beginning the next one, which can lead to unnecessary latency, especially if the nodes are not competing for the same resources, such as with respect to a dataset node, the runtime engine 162 can transfer data for the next iteration while the APU or a network accelerator is processing data in a different memory segment.

With respect to perception, tracking, prediction, and path planning, for example, the capability of the present disclosure to make use of hardware-accelerated tensor operations is advantageous in improving training and inference speeds. Accordingly, the present disclosure is capable of leveraging hardware acceleration if available by utilizing the APU memory 154 . . . 154n. The runtime engine 162, for example, is configured to detect and deploy algorithms to appropriate hardware such as GPUs, TPUs Digital Signal Processors (DSPs), or other appropriate acceleration hardware available. While such automated activity of the runtime engine 162 is believed to be most beneficial, manual configuration of acceleration hardware is contemplated.

In addition to utilizing improved processing to streamline instantiation of the processing pipeline 132, the ability of a user to drag-and-drop and otherwise easily rearrange the selected nodes within the interactive pipeline interface 128 further enhances usability of the system 100. For example, the UI 118 can quickly help users make sense of a complex system and provide a convenient way to rapidly edit node-based systems, e.g., the nodes available from the node database 108 can be easily added or removed from the interactive pipeline interface 128 to facilitate adjustments to the processing pipeline 132 resulting therefrom.

If a modular perception system requires a graphical frontend to run, it may be unable to run on a server that might not have graphical output capabilities. Server-based processing may even be necessary for very large perception models that might otherwise be too large for desktop-sized GPUs. Furthermore, graphical output may consume enough resources to reduce overall throughput, which can delay the processing of a perception pipeline even further. Accordingly, the present disclosure optionally implements the system 100 independently of a specific user interface, e.g., each node is able to operate independently of any specific user-facing interface, while providing enough information to allow graphical-based tools to interface and modify settings for each node.

The system 100 is particularly beneficial in supporting construction, training, and testing relative to the rapid pace of development of perception-based systems. In some examples, the system 100 is designed to bring together state-of-the-art perception algorithms in a manner that is not only flexible but also enables compatibility with new and emerging technologies. The network API 116, optionally operating in concert with a command line interface (CLI) 166, is configured to support and allow users to design and integrate their own networks, data sources, and other processing nodes into the framework architecture 102. In some circumstances, simply providing interfaces to existing datasets and algorithms is not enough, especially for companies that are working on proprietary technology, and as such, the capability of the present disclosure to integrate new modules without necessarily requiring software changes in the core framework is beneficial.

Furthermore, the system 100 is operable in some examples as a modular platform that can exploit and integrate well-established and state-of-the-art perception algorithms while enabling seamless extensions of new perception algorithms and architectures as new paradigms emerge. For example, many traditional object detection frameworks are built on some form of a backbone network, an object detector, and a non-maximum suppression module. Meanwhile, emerging object detection frameworks that may be based on a transformer encoder-decoder strategy are becoming increasingly popular. The system 100 of the present disclosure advantageously enables incorporation of such major extensions and new architectural paradigms, e.g., enables the related datasets, nodes, algorithms, etc., to be incorporated into the processing pipeline 132.

In some examples, PyTorch® is employed as an underlying neural network framework for the system 100 due to its wide use in many existing state-of-the-art networks, excellent documentation, wide compatibility with acceleration hardware, and compatibility with other frameworks in the form of conversion tools. The selection of PyTorch® does not preclude the use of other frameworks; however, it does assist in PyTorch® being available in default configurations and provides the underlying in-device data representation for the default types.

Optionally, in concert with the use of PyTorch®, Python® is a natural fit as the target language of choice, both for the underlying framework itself, as well as the API for developers to build their own processing modules. Python® is commonly used in data processing and neural network development; beyond PyTorch®, several other frameworks either have direct support for Python®, or support through abstraction APIs. Python® 3.10, for example, has successfully run the core components on version 3.8, and the Graphical User Interface (GUI) on version 3.9. As an interpreted language, there are some trade-offs to using Python® instead of a compiled language such as C. Interpreted languages in general are slower, and Python® is no exception. However, there are many options for improving Python® code performance, which can often result in similar performance to C code.

One of the main bottlenecks in many pipeline processors is in datatype transformation at the interface between nodes. In accordance with examples of the present disclosure, a set of datatypes may be utilized. The underlying data, for example, are stored in PyTorch® tensors, using accelerator memory if available, to avoid unnecessary CPU to accelerator data transfers, which are time-consuming operations. By way of example, such predefined datatypes include images with arbitrary channel count; point clouds for lidar, 2D and 3D bounding box detections, 2D pixel and 3D point instance segmentation, and 2D trajectories for trajectory prediction networks. Optionally, an arbitrary tensor data format is utilized to allow networks to provide interfaces that may not fit into an existing type, e.g., using a tensor to pass score information from the 3D detector to the Camera-Lidar.

While there are many ways to structure software to enable extensibility, the present disclosure in some examples leverages the object-oriented capabilities of Python® to provide base class definitions for developers to use to implement nodes to be added to or incorporated with the node database 108, such as with the base object interface.

The base object interface, for example, includes: an object constructor that accepts a Python® dictionary with configuration values and an optional UUID intended for reinitializing a saved configuration from disk; a process( ) function that accepts inputs, processes data according to the node's underlying algorithm, and outputs data to be processed by downstream nodes; a get_config and set_config function for retrieving and changing configuration values, inputs( ) and outputs( ) functions that declare the node's inputs and outputs, which helps ensure that connected node inputs and outputs are compatible before graph processing; a static boolean property such as a can_train function that indicates whether a node has trainable parameters such as for most neural network-based algorithms, and valid that can ensure the underlying node configuration will function correctly; and/or a category function that aids in sorting and discoverability of the node in listings.

In this manner, various properties, such as name and UUID, allow multiple instances of a single node type to coexist within the same graph and be easily differentiated from both a machine and a human perspective, enumerate and verify the interface for each custom node type, which reduces the possibility for user-developed code to function improperly by omitting any required interfaces. While user-developed code may still contain bugs that are only made obvious at runtime, the defined interfaces of the present disclosure allow code to more easily catch otherwise fatal errors using built-in exception handling of Python®, which in turn makes the user development experience easier.

In some examples, the processing pipeline 132 of the present disclosure is structured as an acyclic graph, e.g., data is read from a disk or network-based resource, loaded into device memory (CPU or accelerator memory), then is passed to downstream nodes, which in turn process the data and output the results to other nodes. Each input and output for each node has both an associated Universal Unique Identifier (UUID) that guarantees its uniqueness across the entire graph based on specific metadata, including tensor type and size (fixed or variable).

When connecting two nodes, for example, the datatype and size of the input and output are checked by the runtime engine 162 for compatibility, before the connection is added to an internal database in memory, e.g., contemporaneously with instantiation of the connection lines 146. When a node produces an output, each node that is connected to the output is checked with the runtime engine 162 to determine if all the nodes' inputs have available data for every single input. If the node has all data ready, it processes the data, and the specific connection is marked as completed for the data cycle. If not, the data are stored and the next node in the graph is processed. This process continues until all nodes have completed processing for the specified frame of data, or if all nodes have not processed any data, with the latter condition only occurring if there is a fault within the graph. This process is optionally coordinated using a RampsCore object, which checks node conformance with a RampsNode specification, verifies that the configuration is valid for all nodes, and processes the data through the graph.

While the framework architecture 102 alone is useful for developing integrated pipelines, as both a basis for evaluating the end user experience, and as an example for further development, the system 100 optionally utilizes nodes that incorporate several datasets, 2D and 3D detection and fusion methods, generic data manipulation nodes, and file output nodes. Together, these nodes can be assembled into unique pipelines for processing 2D and 3D data in different ways, which optionally utilize less of the original codebase such that the Software Lines of Code (SLOC) required to implement the system 100 is minimized.

In this regard, dataset sources and detectors typically require other operations to build a complete system, and as such the present disclosure optionally in some examples utilizes built-in nodes for manipulating data and providing file input and output. Such features include tensor slicing for generic tensor resizing and subsampling, 2D label drawing for outputting drawn labels on images, an image output for saving processed images to disk, and/or a tensor output for outputting raw tensors for processing by other software. As previously stated, the limited SLOC required to implement features of the present disclosure is minimized. While there is some common code that is required per node, this burden is typically much lower when compared to other codebases.

As supported above, the present disclosure provides a modular system that enables connecting disparate modules, datasets, and outputs together without extensive development effort, while reducing the total SLOC required via de-duplication of common functions. In some examples, the present disclosure eases node discoverability and provides an easy-to-understand visual representation of the current configuration of the pipeline, while allowing the core algorithms to run on a server with higher processing and acceleration capabilities than a desktop or laptop computer, allowing the present disclosure to be used as a shared resource within a company or academic environment.

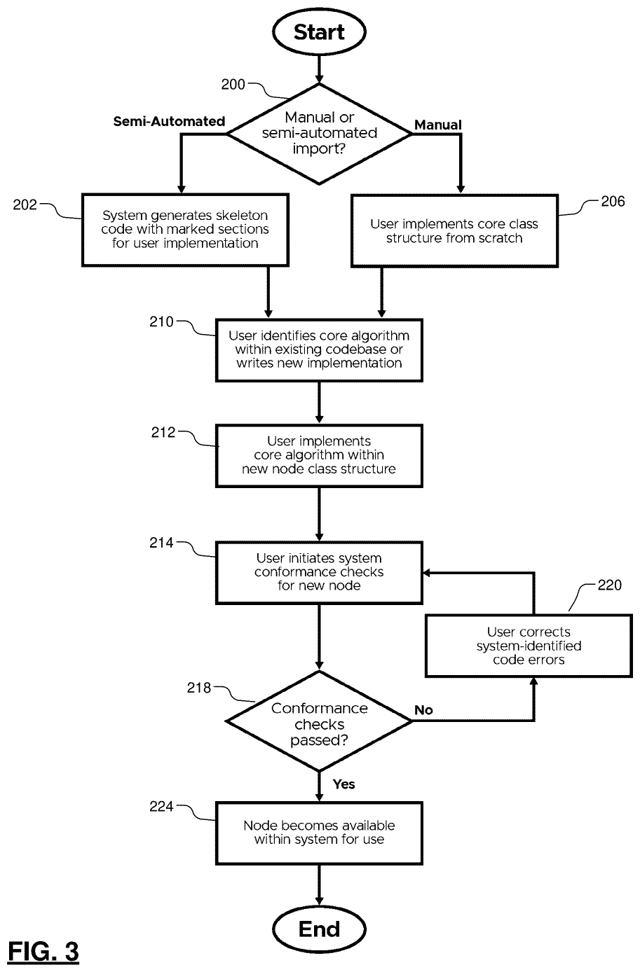

Referring to FIG. 3, a method is observable for incorporating nodes for use with the system 100. In some examples, nodes are incorporated for storage in the node database 108 and subsequent use with the node selection menu 112 to facilitate generating the processing pipeline 132. The nodes, accordingly, can be imported to the system 100 to facilitate constructing, training, and testing a wide variety of neural networks, systems, etc. using various datasets, i.e., data sources, as inputs to facilitate generating datasets, i.e., data sinks, based on the processing thereof with various algorithms, optionally with the output of one algorithm being utilized as an input to another algorithm or the same data set used synchronously or asynchronously with differing algorithms.

At 200, the method includes determining whether the node to be imported is to be imported according to a manual or a semi-automated importation process. The importation process, for example, may be facilitated with the runtime engine 162 interacting with a user via the UI 118. At 202, the method includes generating a skeleton code with marked sections for user implementation in response to determining semi-automated importation at 200, such as with the runtime engine 162. At 206, the method includes the implementation of a core class structure from scratch, such as with a user inputting the corresponding data to the UI 118. At 210, the user identifies whether a core algorithm within an existing code base or a new implementation is to be written. At 212, the user implements the core algorithm within a new node class structure. At 214, the user initiates system conformance checks for the new code. At 218, a determination is made on whether a conformance check for the new code has passed. At 220, if necessary, the user is directed to correct system-identified code errors, i.e., errors identified with the runtime engine 162. At 224, the corresponding node is loaded into the node database 108 and made available for use within the system 100.

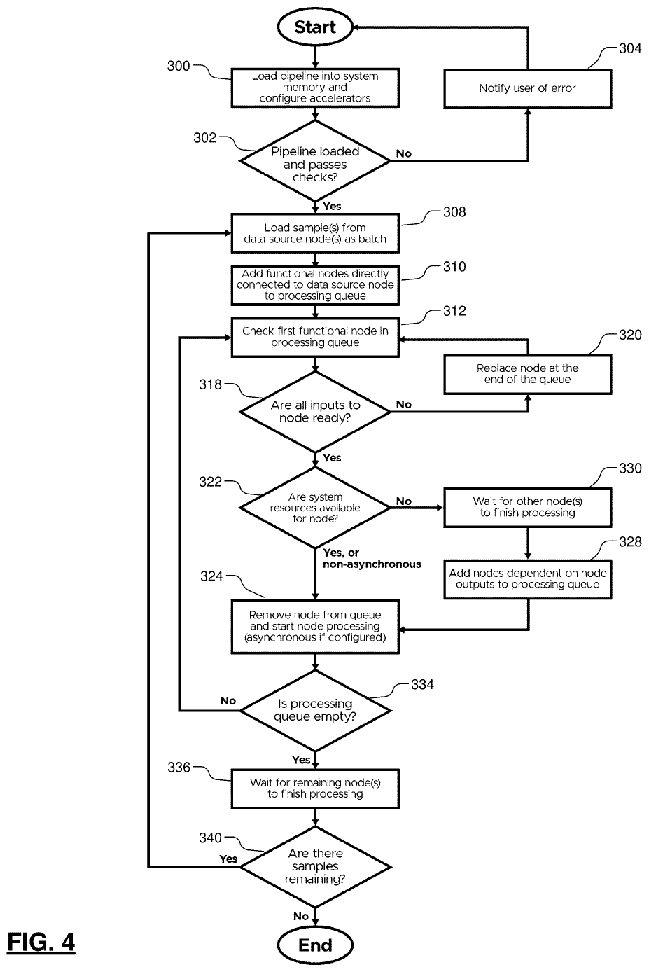

Referring to FIG. 4, a method is observable for instantiating the processing pipeline 132. In some examples, the runtime engine 162 directs the operating system 104 to instantiate the processing pipeline 132 such that the various data sets, algorithms, dependent operations and processes, etc. associated with the included nodes are executed to train, test, or otherwise assess a related system. The method of FIG. 4, for example, is advantageous in allowing an engineer to model a vehicle perception system relative to differing data sources, algorithms, and data sinks.

At 300, the method includes the runtime engine 162 loading the processing pipeline 132 into system memory, e.g., loading the nodes in the processing pipeline 132 into the CPU memory 150 and/or the APU memory 154 . . . 154n. Optionally, the loaded nodes are initially loaded within one of the system memories and thereafter re-loaded according to the optimization strategy. At 302, the runtime engine 162 performs a load check on the processing pipeline 132 to determine whether each of the nodes can be loaded.

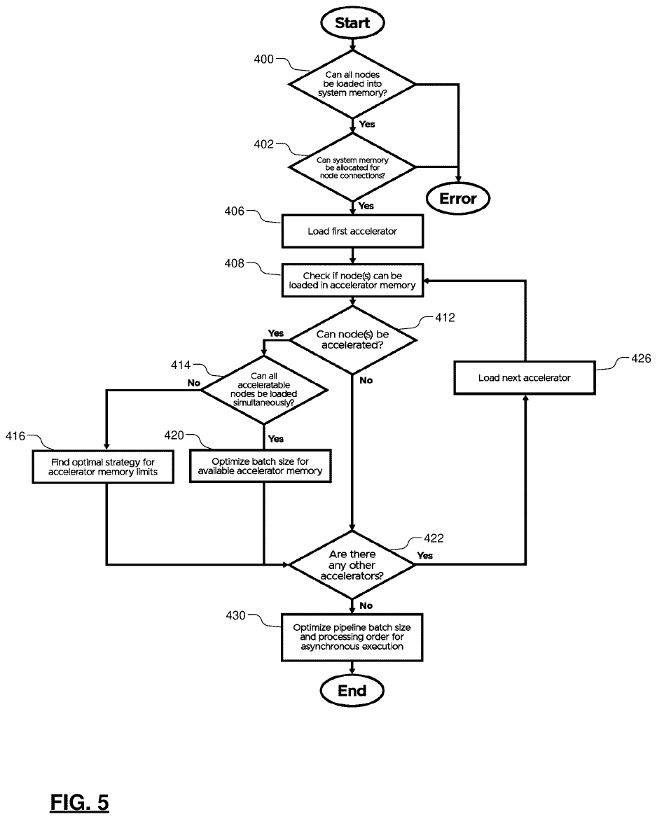

Referring to FIG. 5, a method is observable for performing the load check of 302. At 400, the load check includes the runtime engine 162 determining whether all the nodes from the processing pipeline 132 can be loaded into system memory. At 402, the runtime engine 162 determines whether system memory can be allocated for node connections. At 406, the runtime engine 162 loads a first APU memory of the APU memories 154 . . . 154n. At 408, the runtime engine 162 checks whether additional nodes can be loaded into the APU memories 154 . . . 154n. At 412, the runtime engine 162 determines whether one or more of the loaded nodes can be accelerated. At 414, the runtime engine 162 determines whether all of the nodes capable of acceleration can be loaded simultaneously. At 416, the runtime engine 162 determines an optimal strategy based on limits of the APU memories 154 . . . 154n. At 420, the runtime engine determines an optimum batch size for the available APU memories 154 . . . 154n. At 422, the runtime engine 162 determines whether additional APU memories 154 . . . 154n are available. At 426, the foregoing processes are repeated for loading additional accelerators. At 430, the performance check is completed with the runtime engine 162 determining an optimized processing pipeline batch size and processing order, optionally including asynchronous execution if possible.

Returning to FIG. 4, at 304, an error is provided if all of the nodes in the processing pipeline 132 cannot be loaded. At 308, the runtime engine 162 loads samples from the data source nodes as batches. At 310, the runtime engine 162 adds functional nodes directly connected to data source nodes to a processing queue. At 312, the runtime engine 162 checks a first one of the functional nodes in the processing queue. At 318, the runtime engine 162 determines whether all inputs to the node loaded at 312 are ready. At 320, the node loaded at 312 is placed to the end of the processing queue in the event it is not ready. At 322, the runtime engine 162 determines whether system resources are available for the node loaded at 312. At 324, the runtime engine 162 removes the node loaded at 312 from the processing queue and starts processing of the node using the operating system 104, optionally asynchronously if configured. At 330, if system resources are unavailable, the runtime engine waits for other nodes to finish processing. At 328, the runtime engine 162 adds nodes dependent on other node outputs to the processing queue. At 334, the runtime engine determines whether the processing queue is empty. If the processing queue is not empty, the foregoing sequence repeats with additional nodes beginning at 312. At 336, the runtime engine 162 waits for any remaining nodes to finish processing. At 340, the runtime engine 162 determines whether any more samples are required for processing. If additional samples remain, the process repeats with additional sample loading at 308.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in a different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as a remote or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system for constructing and testing processing pipelines, comprising:
a node database including a plurality of nodes having inputs and outputs defined according to respective input and output tensors, wherein each node of the plurality of nodes executes routines in furtherance of a related task associated with at least one of a data source, a data sink, and an algorithm;
a network application programming interface (API) configured to identify a plurality of selected nodes of the plurality of nodes to be arranged into a processing pipeline based on corresponding user inputs to a user interface (UI);
an operating system coupled with a central processing unit (CPU) having a CPU memory and a plurality of accelerator processing units (APUs) each having an APU memory; and
a runtime engine executable with the operating system to direct instantiation of the processing pipeline according to an optimization strategy, wherein the runtime engine, prior to instantiating the processing pipeline, is configured to perform a conformance check of the processing pipeline and generate the optimization strategy to structure the processing pipeline as an acyclic graph that maximizes use of the APU memory relative to batch sizing of the input and output tensors of the plurality of selected nodes.

2. The system according to claim 1, wherein the network API is configured to present the plurality of nodes stored in the node database to a user to enable selection via a node selection menu of the UI, wherein the network API identifies the plurality of selected nodes comprising the processing pipeline according to corresponding user inputs to the node selection menu.

3. The system according to claim 2, wherein the node selection menu includes an available data source menu to present selectable nodes of the plurality of nodes that operate as a data source, an available data sink menu to present selectable nodes of the plurality of nodes that operate as a data sink, and an available algorithms menu to present selectable nodes of the plurality of nodes that operate as an algorithm.

4. The system according to claim 2, wherein the node selection menu includes an interactive pipeline interface configured to visually represent and spatially arrange the plurality of selected nodes relative to each other in response to corresponding user inputs to the node selection menu.

5. The system according to claim 2, wherein the node selection menu includes an interactive pipeline interface configured to present the plurality of selected nodes and a connection tool configured to draw connection lines between the inputs and outputs of the plurality of selected nodes in response to corresponding user inputs to the node selection menu, wherein the connection lines represent edges and dependent processing pathways between adjoining nodes of the processing pipeline.

6. The system according to claim 2, wherein the runtime engine is configured to perform the conformance check contemporaneously with drawing of connection lines between the plurality of selected nodes to provide real-time conformance feedback via the node selection menu.

7. The system according to claim 2, wherein the conformance check is configured to indicate an error in response to identifying an incompatibility between the input and output tensors of adjoining ones of the plurality of selected nodes connected together in the node selection menu with connection lines, wherein the connection lines represent edges and dependent processing pathways between adjoining nodes of the processing pipeline.

8. The system according to claim 7, wherein the incompatibility is based on a tensor type and a tensor size of the input and output tensors.

9. The system according to claim 1, wherein the runtime engine is configured to assign a universal unique identifier (UUID) to each input and output of the processing pipeline and assign a name to each of the plurality of nodes.

10. The system according to claim 9, wherein the UUID associated with the inputs and outputs and the name associated with the plurality of nodes are operable to permit multiple instances of a node of the plurality of nodes within the processing pipeline to be differentiated from both a machine perspective and a human perspective within the acyclic graph.

11. The system according to claim 1, wherein the plurality of nodes are each configured to implement a base object interface.

12. The system according to claim 11, wherein the base object interface includes an object constructor that accepts a dictionary with configuration values and a universal unique identifier (UUID), a process function that accepts inputs, processes data according to an underlying algorithm, and outputs data to be processed by downstream nodes, a get_config function that retrieves configuration values, a set_config function that changes configuration values, an input function that declares inputs, an output function that declares outputs, a train function that indicates whether trainable parameters are available, a valid function that indicates an underlying node configuration is functioning, and a category function that aids in sorting and discoverability.

13. The system according to claim 1, wherein the runtime engine is configured to instantiate the plurality of selected nodes comprising the processing pipeline synchronously.

14. The system according to claim 1, wherein the runtime engine is configured to instantiate one or more nodes of the plurality of selected nodes comprising the processing pipeline asynchronously.

15. A method for constructing and testing processing pipelines, comprising:
identifying a plurality of selected nodes selected from a plurality of nodes stored in a node database based on corresponding user inputs to a node selection menu presented through a user interface (UI) accessible via a network application programming interface (API), wherein each node of the plurality of nodes includes inputs and outputs defined according to respective input and output tensors and executes routines in furtherance of a related task associated with at least one of a data source, a data sink, and an algorithm;
generating a processing pipeline for the plurality of selected nodes according to a node arrangement of the plurality of selected nodes within an interactive pipeline interface of the node selection menu, wherein the node arrangement is determined according to corresponding user inputs to the node selection menu and includes connection lines between the inputs and outputs of the plurality of selected nodes to represent edges and dependent processing pathways between adjoining nodes of the processing pipeline; and
directing an operating system comprising a central processing unit (CPU) having a CPU memory and a plurality of accelerator processing units (APUs) each having an APU memory to instantiate the processing pipeline according to an optimization strategy, including, prior to instantiating the processing pipeline, performing a conformance check of the processing pipeline and generating the optimization strategy to structure the processing pipeline as an acyclic graph that maximizes use of the APU memory relative to batch sizing of the input and output tensors of the plurality of selected nodes.

16. The method according to claim 15, further comprising performing the conformance check contemporaneously with drawing of the connection lines to provide real-time conformance feedback via the node selection menu, including indicating an error in response to identifying an incompatibility between the input and output tensors of adjoining ones of the plurality of selected nodes connected together with connection lines.

17. The method according to claim 15, further comprising presenting the plurality of nodes in the node selection menu relative to an available data source menu that presents selectable nodes of the plurality of nodes configured to operate as a data source, an available data sink menu that presents selectable nodes of the plurality of nodes configured to operate as a data sink, and an available algorithms menu that presents selectable nodes of the plurality of nodes configured to operate as an algorithm.

18. A system for constructing and testing processing pipelines, comprising:
a node database comprising a plurality of nodes, wherein each node of the plurality of nodes includes inputs and outputs defined according to respective input and output tensors and is configured to execute routines in furtherance of a related task;
a node selection menu configured to present an interactive pipeline interface through a user interface (UI) accessible via a network application programming interface (API), wherein the interactive pipeline interface is configured to present a processing pipeline comprising a plurality of selected nodes in response to corresponding user inputs indicating selection of the plurality of selected nodes from the plurality of nodes in the node database, wherein the processing pipeline includes connection lines between the inputs and outputs of the plurality of selected nodes to represent edges and dependent processing pathways between adjoining nodes in the processing pipeline; and
a runtime engine configured to direct an operating system to instantiate the processing pipeline according to an optimization strategy, wherein the operating system includes a central processing unit (CPU) having a CPU memory and a plurality of accelerator processing units (APUs) each having an APU memory and the optimization strategy structures the processing pipeline as an acyclic graph that maximizes use of the APU memory relative to batch sizing of the input and output tensors of the plurality of selected nodes.

19. The system according to claim 18, wherein the runtime engine is configured to perform a conformance check contemporaneously with drawing of the connection lines to provide real-time conformance feedback via the node selection menu, wherein the conformance check is configured to indicate an error in response to identifying an incompatibility between the input and output tensors of adjoining ones of the plurality of selected nodes.

20. The system according to claim 18, wherein the node selection menu is configured to present the plurality of nodes relative to an available data source menu that presents selectable nodes of the plurality of nodes configured to operate as a data source, an available data sink menu that presents selectable nodes of the plurality of nodes configured to operate as a data sink, and an available algorithms menu that presents selectable nodes of the plurality of nodes configured to operate as an algorithm.
